(19) United States
(12) Patent Application Publication
(10) Pub. No.: US 2004/0035218 A1
(43) Pub. Date: Feb. 26, 2004

(54) Monitoring of concrete vessels and structures

(76) Inventor: Peter O. Paulson, Alberta (CA)

Correspondence Address: BLAKE, CASSELS & GRAYDON, LLP, 45 O'CONNOR ST., 20TH FLOOR, OTTAWA, ON, K1P 1A4, CA

(21) Appl. No.: 10/380,676

(22) PCT Filed: Sep. 25, 2001
(86) PCT No.: PCT/CA01/01341

(30) Foreign Application Priority Data
Sep. 25, 2000 (CA) 2320631

(51) Int. Cl. G01N 3/00

(52) U.S. Cl. 73/803

(57) ABSTRACT

Microcracking in concrete structures is monitored acoustically. The resulting signals can be used to determine corrosion of metal reinforcing wires or rods, or damage occurring from accident or seismic events.

The present invention relates to the monitoring of concrete vessels (such as concrete pipes or containment vessels including water towers and containment vessels for containing accidental discharge of radioactive gases at nuclear facilities) and concrete structures (such as buildings or bridges) to determine possible deterioration of their structural integrity.

### BACKGROUND

Many concrete vessels and structures contain wire reinforcements. It is known to monitor such vessels and structures acoustically, to record the signals arising from the breaking of the wire reinforcements. Examples of such monitoring are shown in U.S. Pat. No. 5,798,457 (Paulson), issued Aug. 25, 1998 and U.S. Pat. No. 6,082,139 (Paulson), issued Jul. 4, 2000.

Other than events caused by breaking of pre- or post-tensioned reinforcing wires, concrete vessels and structures normally do not emit significant acoustic events unless they are placed under stress.

It is well known that on loading of a concrete structure, small cracking sounds can be heard whenever the loading exceeds a previous maximum. This is called the Kaiser effect. It is thought to occur because of the creation of microfractures in the concrete formed by the new level of loading.

Although many concrete vessels and structures have wire reinforcements, there are unreinforced structures, and structures with non-wire reinforcements, such as steel reinforcing bars. The Kaiser effect occurs in any concrete structures or vessels, whether they have wire reinforcement or not.

Systems which monitor structures or vessels for wire breakage do not seek to record the Kaiser effect, because there are other instruments, such as pressure or strain gauges, to record events which load structures or vessels. The other instruments give a quantitative determination of loading, and do not only determine loading beyond the previous maximum loading level.

Further, the acoustic events created by the Kaiser effect do not give off nearly as much energy as those created by wire breakage. Wire breakage typically gives an acoustic event of approximately the same magnitude as hitting the structure with a Schmidt hammer. In a recent test in which the Kaiser effect was caused in a reinforced concrete nuclear containment vessel, a Schmidt hammer gave an acoustic event yielding 30 dB of energy, whereas the Kaiser effect gave 480 events having −30 to 0 dB and only 50 events over 0 dB, none of which were 30 dB or over. Further, Kaiser effect events occur in a narrow frequency band, whereas wire breaks give a much broader range of frequencies. Thus, arrays for listening for wire breaks typically either exclude Kaiser effect events because they are too small or do not have the correct frequency characteristics to be examined as likely wire breaks.

### THE INVENTION

It has now been found that repeated or long term or comparison monitoring of small acoustic events, of the same general frequency and amplitude as those detected in the Kaiser effect, provides valuable information to determine structural damage occurring because of corrosion of reinforcing steel wires or bars, or damage from external forces such as earthquake or collision.

Typically, such events occur in one or more narrow bands of frequencies (specific to the container or structure being monitored) within the 2-12 KHz range, with most signals of interest being in the 8-12 KHz range. It is usually sufficient to record signals in the frequency range of about 2 KHz to 12 KHz in order to get all signals of probable interest. They can be detected using any suitable acoustic detector coupled to the concrete structure so as to receive acoustic emissions at these frequencies. Acoustically, the noises are sharp cracking sounds, and can be likened to the sound of popcorn popping. If several acoustic detectors are used, the locations within the vessel wall or the structure at which the cracking sounds originate can often be located, by using methods analogous to those used to locate wire breaks in the two Paulson patents cited above.

### DRAWINGS

The invention will be further explained with respect to the drawings, in which:

FIG. 1 is a perspective view (not to scale) of a concrete pressure vessel with a suitable monitoring equipment configuration for use with a repeated monitoring or continuous monitoring embodiment of the invention.

FIG. 2 is a perspective view (not to scale) of a concrete pressure vessel with a suitable monitoring equipment configuration for use with a comparative monitoring embodiment of the invention.

### PERIODIC MONITORING EMBODIMENT

According to one embodiment of the invention, a base test is made with the structure or vessel loaded to a predetermined amount. In the case of a vessel such as a water tank or nuclear containment vessel, the loading can conveniently be by pressurizing the contents of the vessel to a predetermined pressure. In the case of a structure, such as a bridge or a building, the test can be by placing test loads of predetermined weight in prechosen locations on the bridge deck or floor of the building. Loads of predetermined weight can also be used for vessel testing, although they are not preferred.

The loading for the base test (hereinafter called the “base load”) should be chosen to be a loading which exceeds the loading that the vessel or structure would encounter in normal use. Typically, a base load which is 1.5 to 10 times the load encountered in normal use would be suitable. It is of course desirable that the load chosen is within the vessel's or structure's design limits, to prevent damage to the vessel or structure.

It is not necessary that the base load exceed any load which has previously been applied to the vessel or structure. If it does exceed the greatest previous load that has been applied, a Kaiser effect will occur when and where it is applied. This can be of interest if multiple sensors have been positioned, because the Kaiser effect arises from microcracking and often the locations of the microcracking can be found precisely, from the locations of the sensors and the time of arrival of the acoustic signal at each sensor, as disclosed in the Paulson patents cited above. These locations of microcracks are useful to know, as these locations are likely to be ones where there is considerable stress, and which would benefit from frequent inspection by conventional means during the life of the structure.

If the base load does not exceed any load previously applied to the vessel or structure, there will be no Kaiser effect. In some cases, previous loading may be exceeded in some portions of a structure or vessel but not in others, in which case there will be a Kaiser effect in the portions where previous loading was exceeded, and no Kaiser effect in other portions.

The presence or absence of the Kaiser effect when the base test is carried out is not important to this embodiment. What is important in the embodiment being described is that testing is done on several occasions spaced over time, using the base load or a somewhat lesser load which still exceeds the normal load encountered in use of the vessel or structure. Because the acoustic events propagate easily through concrete, it is not necessary that the sensors be in exactly the same position in each test, although it may be convenient to leave the sensors permanently in position between tests in most cases, to reduce the set-up time for each test. The loads should preferably be applied at or near the location where they were applied in the base test, to facilitate comparison between test results. In the case of pressurizing a container, the load will automatically be applied in the same location as the base test if the same container, or the same subcompartment of a container, is pressurized. Where the load is a weight, applying the load at or near the previous location can conveniently be accomplished by marking the structure or vessel at the time of the base test at the locations of the weights.

If, in a subsequent test using the same load as the base load or a lesser load, acoustic events similar to the Kaiser effect are heard, this indicates that the structure has been damaged. This damage may have occurred by the corrosion of a wire or reinforcing bar, or because of structural damage from earthquake, collision or the like. The acoustic events are thought to indicate that the weakened structure is undergoing microcracking, even though it would not have undergone microcracking at the loading applied had it not been damaged.

Where there are several sensors, the locations from which the acoustic events were emitted can be found using the location techniques discussed in the Paulson patents cited above or any other known technique for locating the source of acoustic emissions. There are typically many very small acoustic events, and a few larger ones (eg above 0 dB.) Where one or more of the larger events has been recorded by several sensors, the location techniques can be applied to find its origin. Even if the concrete is curved (as in the sidewall of a cylindrical pressure vessel), virtually all of the energy passes through the concrete, and the concrete can be considered for the purpose of finding the origin as though it were a flat sheet. The origin can then be examined using conventional techniques, and the damage can be repaired before it becomes serious.

In a preferred embodiment, tests are repeated periodically, (for example once every 1-6 months) using loads equal to, or less than the base load. These permit the finding of new damage which has occurred since the previous test. In this way, damage can often be detected and corrected before it becomes major enough to threaten the structural integrity of the vessel or structure.

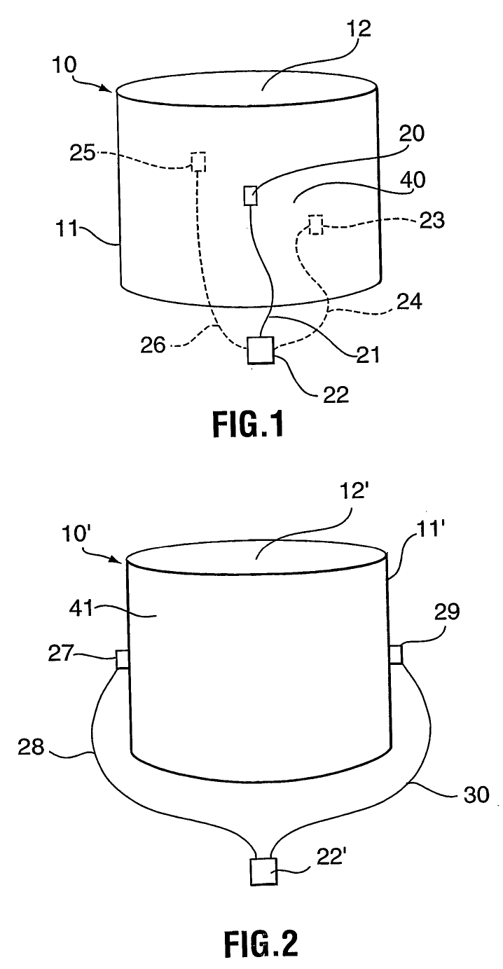

FIG. 1 illustrates an equipment configuration suitable for this embodiment. Pressure vessel 10 is a concrete vessel suitable for containment of radioactive vapour in case of an explosion at a nuclear power plant. It has a cylindrical concrete sidewall 11 and a circular concrete roof 12. It also has a circular concrete floor (not shown). A typical such vessel is for example 10 m. in diameter and the sidewall 11 is 13 m. in height and ½ m. thick. It is designed to operate at an outward pressure from its contents of 80 pounds per square inch over atmospheric pressure (80 psig), and to be able to withstand considerably higher outward pressures in an emergency.

On sidewall 11 is mounted acoustic sensor 20, which senses acoustic events in a frequency range of 2 KHz to 12 KHz. The acoustic events sensed in this range are primarily acoustic waves which reach the sensor through the concrete wall. Acoustic sensor 20 is connected by cable 21 to recording device 22 so that acoustic waves registering at sensor 20 cause sensor 20 to emit electrical signals which are recorded at recording device 22. Preferably the recording device 22 is a computer which also has the capacity to analyze the signals, by making Fourier transforms thereof to determine their spectral density.

Optionally, additional sensors 23 and 25 are located on the sidewall 11, and are connected to recording device 22 by cables 24 and 26 respectively. Preferably, the sensors used are the same as sensor 20.

To provide a base level for later comparison, the pressure in the containment vessel is raised to 120 psig, which is a pressure level unlikely to be encountered in normal operation. If the vessel has not previously been pressurized to this pressure, Kaiser events will occur. If it has been pressurized previously to this level, Kaiser events will not occur in the absence of damage or corrosion. If Kaiser events do occur, they are preferably recorded, and the locations at which they occurred are inspected to see if there was damage.

In subsequent periodic tests, the pressure in the vessel is raised to a test pressure of 120 psig or, if preferred, to a lower test pressure which is still in excess of the normal operating pressure of 80 psig., such as for example 100 psig. When the test pressure is reached, the sensors are monitored for acoustic events in the range 2-12 KHz. It is expected that no acoustic events will be recorded (except possibly ones from extraneous sources, such as passing traffic etc.) If acoustic events are recorded in this range, and are not other wise explicable, damage or corrosion to the structure is considered likely. Preferably, the origin or origins of the acoustic events are determined, as for example at 40. The sidewall 11 is then examined at location 40 by conventional means to determine whether there is corrosion or damage at that location.

### Continuous Monitoring Embodiment

In another embodiment of the invention, continuous acoustic monitoring for acoustic events in the 2-12 KHz frequency range, or some frequency range within this selected after consideration of the particular vessel or structure, is carried out. The preferred range is 8-12 KHz. Other frequencies can either be discarded or can be recorded for purposes unrelated to this invention Suitable filters can be included if desired to record only those acoustic emissions which are in the frequency range of 2-12 KHz or some smaller frequency range within this range where the structure of vessel is known to exhibit a Kaiser effect.

Where acoustic events occur in the selected range, the recorded signals from such events can be examined later and compared with reference recordings of cracking sounds recorded in previous tests the same structure or similar structures, to see if the newly recorded acoustic events have similar energy spectra and duration, and therefore are likely to have been caused by microcracking. Alternately, the acoustic events can be compared to reference recordings by computer immediately after the events are recorded, and a report can be generated immediately if the events are identified as probable microcracking. This embodiment permits the collecting of microcracking information at the time the microcracking occurs. The origin of the acoustic events can be found by applying known methods of analysis (such as those shown in the Paulson patents discussed) to the output of several sensors. In cases where damage occurs through sudden events (such as a collision or a seismic even such as an earthquake) this embodiment permits location of possibly damaged areas, so that they can be inspected and repaired if necessary.

Preferably, when continuous monitoring is carried out apparatus such as that shown in FIG. 1 is used. Testing is first done by loading the structure, as in the tests discussed above, to determine the frequency spectrum and duration of acoustic events made by microcracking in the structure. Then, recording device 22 is a computer programmed to recognize the acoustic “signatures” of the microcracking events, in terms of frequencies and duration. Events having similar frequencies and duration can be logged for further spectral examination to see if they are in fact microcracking events, or can immediately be used to cause an on-site inspection to be carried out.

As discussed above, it has been found that, when the structure has been damaged, the acoustic events representing microcracking appears at a lower load level than was previously the case. For example, in a containment vessel, corrosion of reinforcing bars may produce weakening of some sections of the vessel. If acoustic monitoring of the entire vessel shows the appearance of microcracking at a lower pressure than was previously the case, the existence of the damage can be discovered, and its location can be determined. Similarly, the appearance of cracking events during a seismic event allows damaged areas to be identified even if the cracking is not visible on the exterior of the vessel. Subsequent pressurization of the vessel can then be carried out to reveal information about the impact of the damage on the ability of the vessel to contain required pressures. Thus small or concealed damage can be located before it has a chance to get worse or cause a failure of the vessel of structure.

Analysis of the Seriousness of Cracking

In a further embodiment, useable in association with either periodic testing under load or continuous monitoring, the signals showing cracking are examined to assess the seriousness of the cracking. Typically, the signals are a series of individual, discrete, signals. The number of such signals per unit of time is examined. When a structure or vessel is loaded in excess of its previous loading, the Kaiser effect gives rise to signals. It is found that the rate of cracking caused by the Kaiser effect normally diminishes quickly after a given load is achieved. Depending on the structure, the rate of acoustic events (number of acoustic events in the 2-12 KHz range per second) diminished by half in an approximately constant period after the greater pressure than previous had been reached. For any structure or vessel, the decrease in rate is approximately constant and characteristic to that vessel. For some vessels, the rate decreases by half every 10 minutes after a new pressure level had been achieved, and for others the rate decreases by half in less than two minutes. Generally, it is expected that the rate will decrease by half in from 15 seconds to 15 minutes, depending on the particular structure or vessel.

Periodic tests of pressure vessels or structures according to the invention show the same pattern where the vessel or structure is loaded to a loading at or below previous loadings, but where there has been minor corrosion damage between tests: i.e., the rate of acoustic events reduces approximately by half every 15 seconds to 15 minutes minutes after a level of loading tat gives rise to acoustic emissions is reached and maintained. Therefore, if the rate of diminution of acoustic emissions does not diminish by half in a time period of the order of 15 seconds-15 minutes, then the vessel is not responding as expected and requires immediate attention. A steady rate of the emissions denoting cracking, for example, would indicate progressive damage to the vessel is occurring even during the test. Under such circumstances, the test should be discontinued, even though no structural damage is evident, and steps should immediately be taken to do conventional inspection and possible repair. Similarly, during continuous monitoring, a steady rate of acoustic events denoting cracking indicates that immediate conventional inspection of the vessel or structure is required.

Comparative Monitoring Embodiment

In another embodiment, monitoring is done where there is reason to suspect that there has been corrosion or damage in a particular portion of a vessel or structure, but where there are no records of previous monitoring with a base load or of continuous monitoring. In such a case, the location suspected of corrosion or damage is monitored, and another location is monitored under similar load for comparison. The other location is chosen to be one which is as similar as possible to the expected damaged location in its construction and load bearing characteristics. For example, if damage or corrosion to one portion of the sidewall of a water tank having a cylindrical sidewall is suspected, the comparative portion can suitably be the portion directly across the diameter of the tank, if such section has similar thickness and reinforcement to the suspect portion, and is not suspected of being corroded or damaged. The two locations are then monitored as the load is increased. If the suspected damaged or corroded location yields acoustic signals showing microcracking at a lower load than the comparative location, it is considered that damage or corrosion has occurred at the suspect location.

The equipment for doing this is shown in FIG. 2. FIG. 2 shows containment vessel 10′ having sidewall 11′ and roof 12′ as vessel 10, sidewall 11 and roof 12 in FIG. 1. A recording device and computer 22′ (as device 22 in FIG. 1) is also provided. Damage is suspected at 41. Accordingly sensor 27 is placed close to the location of the suspected damage and is connected to recording device 22′ by cable 28. Sensor 29 is placed in a location believed to be undamaged, and as far as conveniently possible from location 41, to reduce the likelihood that it will record acoustic events from location 41. Sensor 29 is connected to recording device 22′ by cable 30.

The pressure in vessel 10′ is then slowly increased, and the signals received at device 22′ are monitored. If signals representing acoustic events in the 2-12 KHz range are received from sensor 27 before similar signals are received from sensor 29, this confirms the suspected damage in or near the location 41. If desired, several sensors could be placed around location 41, and the pressure increased further, to determine the exact location of the damage, using known location techniques.

What is claimed is:

1. A method of inspection of concrete structures which comprises:
a) conducting a base test by loading the structure with a base load which is considerably in excess of the load to which the structure is exposed in normal use,
b) removing the base load,
c) subsequently conducting at least one further test by loading the structure with a test load equal to or less than the base load, and exerting loading in approximately the same location as the test load;
d) noting acoustic signals (if any) which are detected by at least one sensor in contact with the structure while the structure is loaded with the test load.

2. A method as claimed in claim 1, where the acoustic signals are detected at one or more frequencies in the range of 2 KHz to 12 KHz.

3. A method as claimed in claim 1 or claim 2, in which the acoustic signals are detected by a plurality of sensors, and the origin of at least some such signals is determined by comparing the signals detected at each sensor.

4. A method of inspecting concrete structures which comprises
(a) loading the structure to a loading where microcracking occurs,
(b) determining the acoustic signature acoustic events arising from of microcracking in the structure
(c) subsequently monitoring the structure for acoustic events having that acoustic signature.

5. A method as claimed in claim 4, in which the acoustic signature comprises a frequency or range of frequencies within the range 2 KHz to 12 KHz which at which acoustic events occur in the concrete of the particular structure as a result of microcracking.

6. A method as claimed in claim 4 or 5 in which the acoustic signature comprises the energy spectra of acoustic events arising from microcracking.

7. A method as claimed in claim 4 or 5 in which the acoustic signature comprises the duration of acoustic events arising from microcracking.

8. A method of inspection of structures which comprises,
a) positioning at least three acoustic sensors in locations to sense acoustic waves within the structure,
b) monitoring the output of such sensors,
c) if and when such sensors detect signals characteristic of concrete microcracking, determining the probable origin of such signals, and
d) inspecting the structure in the vicinity of the probable origin for evidence of damage.

9. A method of inspection of A concrete structure which is suspected to be damaged which comprises
(a) placing two acoustic sensors to monitor acoustic events occurring in the concrete of the structure, one such acoustic sensor being placed proximate to the suspected damaged area and one acoustic sensor being placed remote from the suspected damaged area in an area believed to be undamaged
(b) loading the structure equally at the locations of the two sensors,
(c) gradually increasing the loading equally at the locations of the two sensors, and
(d) noting whether acoustic events are detected by the sensor proximate the suspected damaged area at a loading at which similar acoustic events are not detected at the sensor remote from the suspected damaged area.

10. A method as claimed in claim 9, in which, if the sensed acoustic events from the sensor proximate the suspected damaged location do not decrease by half within 15 minutes at the loading at which they are first detected, the loading is decreased.

11. A method as claimed in any of claims 1-3, in which, if acoustic events are noted at the test load, then such signals are monitored and a determination is made as to how long it takes for the rate of such signals to decline by one-half.

12. A method as claimed in any of claims 4-7, in which acoustic events bearing the acoustic signature of microcracking are monitored and a determination is made as to how long it takes for the rate of such signals to decline by one-half.

13. A method as claimed in any of claims 1-12, in which the structure is a pressure vessel, and the loading is changed by changing the pressure in the vessel.
